(19) United States
(12) Patent Application Publication
(10) Pub. No.: US 2007/0149135 A1
(43) Pub. Date: Jun. 28, 2007

(54) Information transfer method and system

(75) Inventors: Peter Larsson, Solna (SE); Johan Nystrom, Stockholm (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET LM ERICSSON (PUBL), STOCKHOLM, SWEDEN S-164 83 (SE)

(21) Appl. No.: 10/584,129

(22) PCT Filed: Dec. 23, 2003
(86) PCT No.: PCT/SE03/02083

§ 371 Date: Jun. 23, 2006

(51) Int. Cl. H04B 17/00

(52) U.S. Cl. 455/67.13

(57) ABSTRACT

A multiple path information transfer system in a cellular radio network includes several receivers (BS-1, . . . , BS-N) for receiving radio signals representing digital information from at least one signal source. From each received radio signal a corresponding digitized baseband signal that contains soft information is extracted. Compressing units (10) compress the soft information to produce compressed baseband signals. These compressed signals are forwarded to a combining unit over a transport network. A de-compressor (16) de-compresses the forwarded signals to at least approximately restore the baseband signals. The de-compressed signals are combined (18-22) and the combined signal is decoded to at least approximately restore the digital information.

### TECHNICAL FIELD

The present invention relates generally to information transfer, and especially to multiple path information transfer in cellular radio networks.

### BACKGROUND

One method to enhance radio network performance in the uplink of a cellular radio network is to use signals received from multiple base stations. In WCDMA (Wideband Code Division Multiple Access) this method is denoted soft handover (HO) and operates such that decoded packets, for any user in soft handover mode, are sent from the base stations (BSs) over the transport network and subsequently “combined” in a radio network controller (RNC). WCDMA uses a rather “hard” version of soft handover, which is essentially selection diversity. It is, however, well known that optimum soft handover in cellular radio networks is obtained by sending soft information from several base stations to a central node, e.g. RNC, where it is combined with maximum ratio combining (when noise and interference from the different BSs are uncorrelated). An essential drawback of this optimum soft handover, however, is that it is very costly in terms of required capacity of the transport network between base stations and the RNC, due to the increased amount of information that has to be transferred in soft form.

Reference [1] describes several site diversity methods. However, a common feature of all the described methods is that they send primarily hard coded information (either channel encoded or completely decoded) to an exchange for “combining” (essentially majority selection).

Reference [2] describes a method in which each base station performs a complete decoding of received blocks, but initially only sends a quality measure to a mobile services switching center (MSC). The MSC determines the best quality measures and requests the decoded blocks from the corresponding base stations for “combining” (majority selection).

### SUMMARY

An object of the present invention is to increase the amount of soft information that can be transferred over a transport network without overloading it.

This object is achieved in accordance with the attached claims.

Briefly, the present invention is based on the idea that the soft information can be compressed into an at least approximately restorable form before it is transferred from a base station over the transport network to a receiving central node. By decompressing the soft information at the receiving central node, typically an RNC, the soft information is at least approximately restored and may be used for combining with corresponding soft information from other base stations to improve decoding.

According to another aspect, the invention offers the possibility of building simpler base stations and concentrate the processing power to the central node.

The invention has several advantages.
1. Assuming more advanced signal processing in the cellular network, the performance of the cellular network can be improved for a fixed amount of transport network resources.
2. Assuming more advanced signal processing in the cellular network, the amount of network resources may be reduced for fixed cellular network performance, which leads to reduced operator costs.
3. The invention is a prerequisite for making more advanced signal processing in the cellular network viable.

### BRIEF DESCRIPTION OF THE DRAWINGS

The invention, together with further objects and advantages thereof, may best be understood by making reference to the following description taken together with the accompanying drawings, in which:

FIG. 1 is a block diagram of a prior art cellular radio network;

FIG. 2 is a block diagram of another prior art cellular radio network;

FIG. 3 is a block diagram of still another prior art cellular radio network;

FIG. 4 is a block diagram of a first exemplary embodiment of a cellular radio network in accordance with the present invention;

FIG. 5 is. a block diagram of a second exemplary embodiment of a cellular radio network in accordance with the present invention;

FIG. 6 is a block diagram of a third exemplary embodiment of a cellular radio network in accordance with the present invention;

FIG. 7 is a block diagram of a fourth exemplary embodiment of a cellular radio network in accordance with the present invention;

FIG. 8A-E illustrates an exemplary signal representation that can be used in the embodiment of FIG. 7; and

FIG. 9 is a flow chart of an exemplary embodiment of the method in accordance with the present invention.

### DETAILED DESCRIPTION

In the following description the same reference designations will be used for the same or similar elements throughout the figures of the drawings.

Furthermore, for the purposes of the present application, the expressions “several” and “multiple” should be interpreted as “at least 2”.

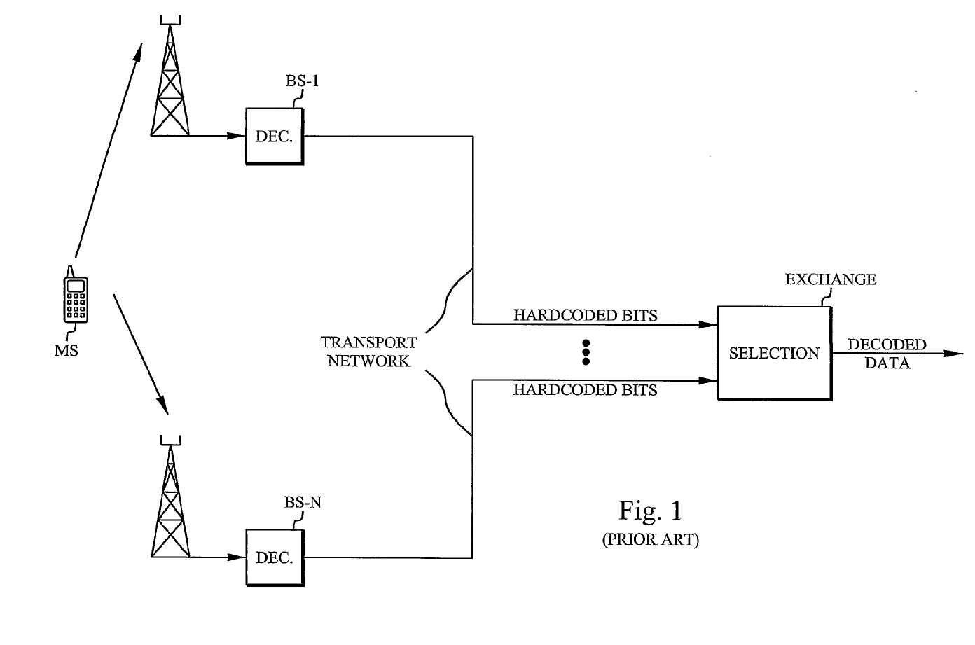

Before the invention is explained in detail, the prior art described in [1] will be briefly described with reference to FIG. 1-3.

A basic architecture of a cellular radio network employing site diversity is shown in FIG. 1. A mobile station MS transmits information, which is received and completely decoded by several base stations BS-1, . . . , BS-N. Each base station is connected to an exchange over a transport network. The exchange receives decoded signals from the base stations and selects one of them.

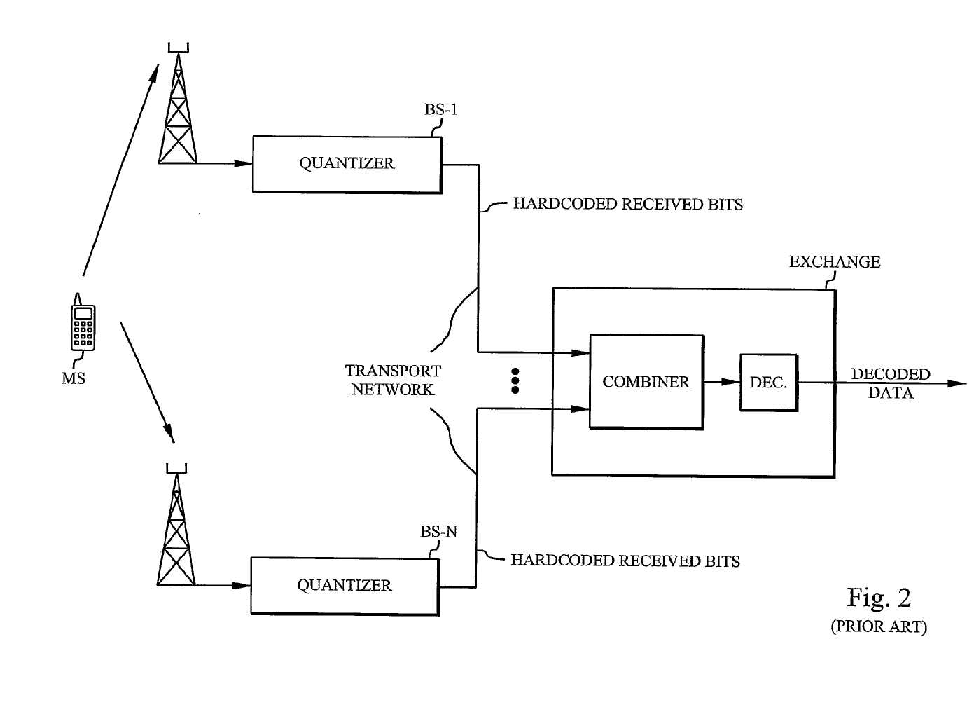

In FIG. 2, instead of completely decoding the received signals, each base station only performs quantization and sends the channel encoded signals to the exchange, which combines them and decodes the combined signal with error correction. The possibility of including soft information, such as received power level, is also mentioned.

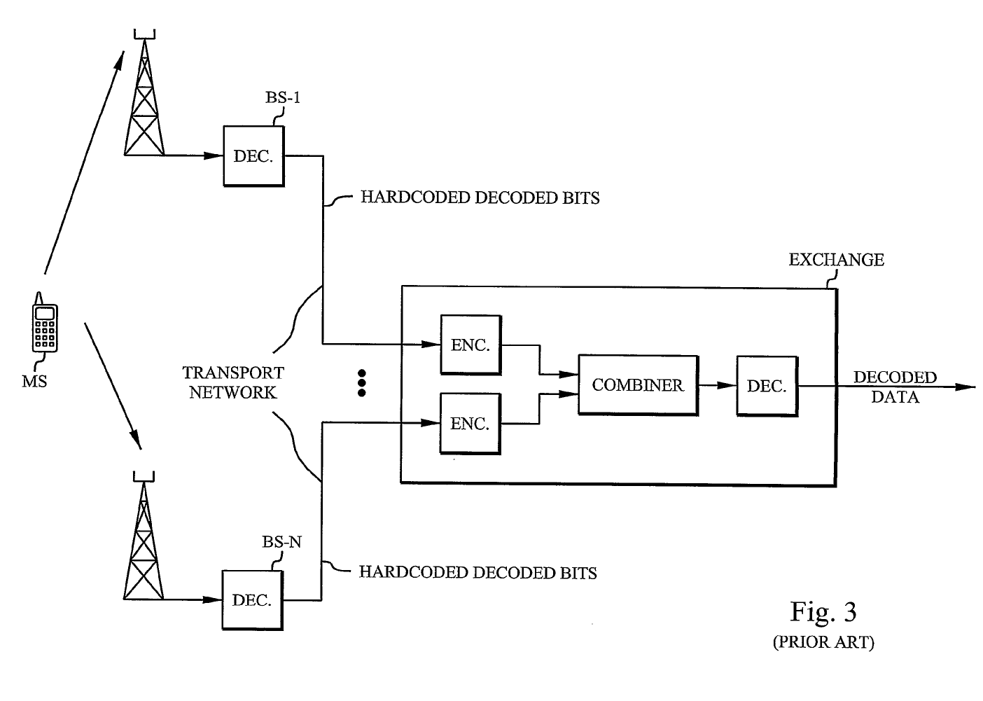

In the prior art embodiment illustrated in FIG. 3, the base stations decode the received signals and send them (possibly with added error presence/absence information) to the exchange, where they are re-encoded, combined and decoded.

A problem with the described prior art is that too many hard decisions have already been made at the base stations, which hinders efficient combination and decoding of the signals received at the combining node.

On the other hand, optimum decoding would require the RNC (or MSC or soft handover device (SHOD)) to have access to maximally soft information. Ideally this would mean the digitized (typically complex) baseband signals from the A/D converters in the base stations or other parameters representing the reliability of estimates of bits or symbols. However, this is typically not possible, since this would require a very high capacity transport network, as the following example will illustrate.

Consider K information bits that are encoded into N code bits (N>K) using a rate R=K/N channel code. Furthermore, assume that these N code bits are transmitted from the MS using N/3 8-PSK (Phase Shift Keying) symbols (since each symbol represents 3 bits this means that 3N/3=N bits will be transmitted). At each BS after demodulation (but before channel decoding) there will be N reliability values (soft information), each requiring say X bits, where X typically is 10-15 bits (fewer and more are also possible). Sending this soft information to the RNC for soft HO requires XN=X/R*K bits. Since K bits would be sent if the signal received by the base stations would be completely encoded for a hard HO, this means that the number of bits to be sent over the transport network is magnified by a factor X/R. With X about 10-15 and typical values of R ranging from 1/5 to ⅞, this means up to 75 times more information bits compared to the hard HO case.

The present invention introduces soft information compression at the base stations and subsequent de-compression at the decoding node as a method to reduce this overhead significantly. The compression may be constant rate or variable rate. In the latter case, the reduction in overhead varies, but on the average a significant reduction is obtained.

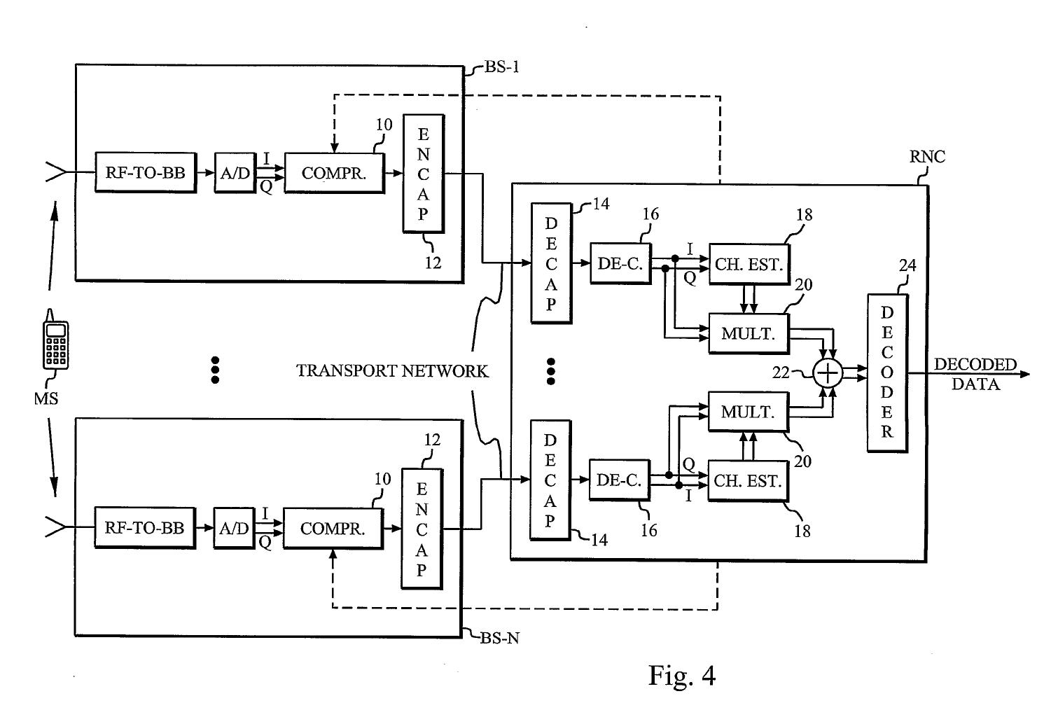

Exemplary embodiments of the invention will now be described with reference to FIG. 4-9. In the illustrations only elements necessary for explaining the inventive idea have been retained in order to avoid cluttering of the figures. For example, interleavers are optional and may or may not be located anywhere in the receiver chain. It is clear to a person skilled in the art that the signal to be compressed can be taken before or after such an interleaver. Furthermore, between a block and the next block there may be conversion units so that the output from the first block is adapted to the input of the second, for example the output from a demodulator may be a signal constellation point from say an 8-psk constellation, but the input to the decoder may take individual bits as input, hence the constellation point needs to be converted into corresponding 3 bits. Furthermore, reliability values may be calculated for these bits. Such conversion units are well known and it is clear that the compression can take place before or after such a conversion without changing the basic concept of the invention. For simplicity such conversions units will be omitted in most figures.

FIG. 4 is a block diagram of an exemplary embodiment of a cellular radio network in accordance with the present invention. This embodiment is very simple and is especially suited to explain the basic concept. A signal source, in the example a mobile station MS, transmits radio signals representing digital information to several base stations BS-1, . . . , BS-N, where N is a positive integer greater than 1. Each base station includes traditional base station equipment, such as a radio frequency (RF) section and an intermediate (IF) frequency section for down conversion to baseband (BB). These functions have been collected into the RF-TO-BB block. The output signal from this block is forwarded to an analog/digital (A/D) converter. In this exemplary embodiment it is assumed that the received signals are quadrature amplitude modulated (QAM), for example 4 QAM. This means that the A/D converter will produce a baseband signal including both inphase (I) and quadrature (Q) components, each with a resolution of, for example, 10-15 bits. In this embodiment these I and Q components represent the soft information to be sent to the decoding node, for example an RNC, MSC or SHOD. However, before they are sent to the RNC they are forwarded to a compression unit 10, which compresses the soft information. The compressed soft information is forwarded to an encapsulating unit 12, which puts the information into packets suitable for transfer to the RNC over a transport network. At the RNC the compressed information from the base stations is received by decapsulating units 14, which retrieve the compressed soft information. This compressed information is decompressed in a set of de-compressors 16, which at least approximately restore the I and Q components originally sent from the respective base stations. The restored I and Q components are forwarded to a channel estimator 18 and a multiplier 20. Channel estimator 18 determines a channel estimate from each received signal. This estimate is used to calculate a complex number, which is forwarded to multiplier 20 to compensate for channel attenuation and phase shifting. After multiplication the compensated signals are maximum ratio combined in an adder 22, and the combined signal is then decoded in a decoder 24 in the same way as in a base station. An alternative is to perform the channel estimation and compensation directly in the base station before compression.

An essential step of the present invention is the compression/de-compression of the soft information. The compression may be, and typically is, lossy to obtain highest possible compression. This means that the de-compressed soft information may not be exactly equal to the original soft information. Instead it may represent an approximation of this information. The compression should, however, be such that the de-compressed soft information still contains enough information to accurately model the reliability parameters it represents. In the example in FIG. 1, a suitable compression method would be vector quantization of the complex numbers represented by the I and Q components. This vector quantization may be performed on each I,Q pair. An alternative and more efficient approach is to group several I,Q pairs into a multidimensional vector with complex valued components, and vector quantize this multi-dimensional complex vector instead.

Vector quantization is a well-known compression method that uses a table (often called a codebook) of predetermined vectors. The quantization is accomplished by comparing each vector in the table with the vector to be quantized. The vector in the table having the shortest “distance” to the desired vector is selected to represent it. However, instead of sending the selected vector itself, its table index is selected to represent the vector (this is where the compression is obtained). The de-compressing end stores the same table and retrieves the approximation vector by using the received index to look it up in the table.

A further compression may be obtained by Huffman coding the vector indices. This means that the most frequently used lookup table indices are assigned the shortest codes, whereas less frequently used indices are assigned the longer codes.

A variation of the described vector quantization is to use it iteratively. In a first step the vector c(i) that most resembles the desired vector is selected from a first codebook. Then a new vector is formed by the difference between the desired vector and the selected vector c(i). This vector is vector quantized by selecting the vector d(j) that most resembles the difference vector from another codebook. This process may be repeated several times. Finally, the quantization is represented by the selected indices i, J . . . .

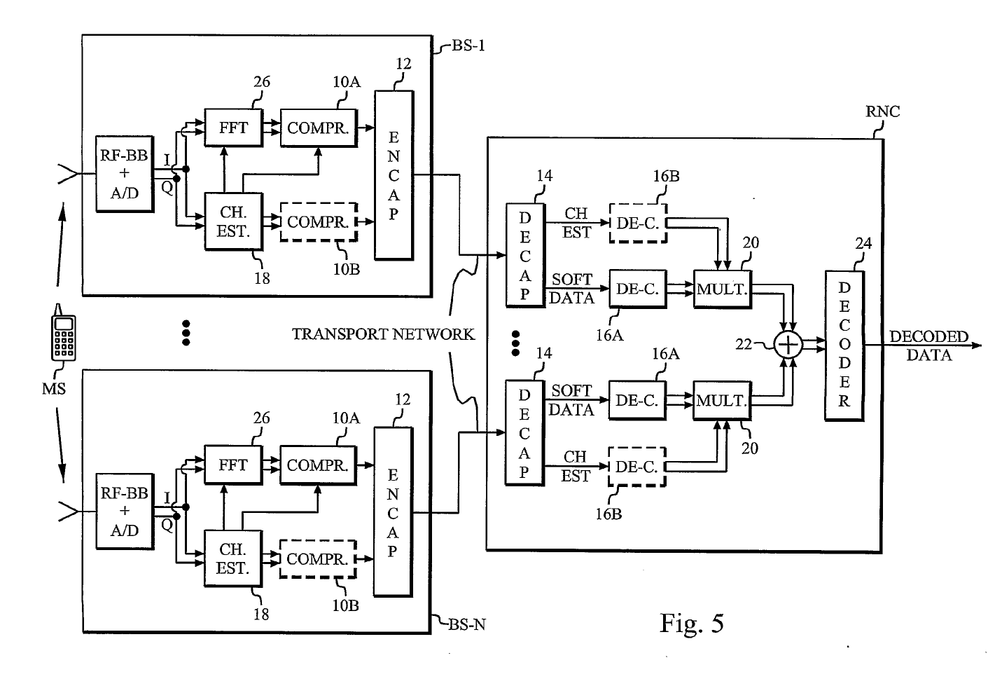

FIG. 5 is a block diagram of a second exemplary embodiment of a cellular radio network in accordance with the present invention. This embodiment is based on an OFDM network. The difference between this embodiment and the first embodiment is that the digital signal processing in the base stations goes one step further in the decoding process before the compression and forwarding to the RNC is performed. Thus, an FFT block 26 performs a Fast Fourier Transformation (FFT) on the A/D converted complex data. This data is also used to calculate a channel estimate in channel estimator 18. The channel estimate of the strongest signal may or may not be used for equalization in the receiver. The use of equalization enables even more efficient compression. If equalization is used in the receiver, only amplitude gain but no phase information of the channel estimate is necessary to send to the RNC. After the FFT the transformed soft complex data is compressed in a compression unit 10A, for example by vector quantization as described above. Optionally (as indicated by the dashed lines) the channel estimate may also be compressed in a compression unit 10B, for example by vector quantization (this may not be necessary, since the channel estimate typically is compact already). The compressed soft data and channel estimate are forwarded to encapsulation unit 12 and sent to the RNC. At the RNC the signals received from the base stations are decapsulated and separated into soft data and channel estimates. These signals are de-compressed in de-compressors 16A and 16B (optional), respectively. As in the first embodiment the channel estimate is used to compensate for channel attenuation and phase shifting. The compensated complex signals are then added in adder 22 and the resulting signal is decoded in decoder 24.

In the embodiment of FIG. 5 the signals in the base stations are compressed after FFT block 26, since the network is an OFDM network. If this is not the case, block 26 could be replaced by an equalizer or a RAKE block. In addition to the FFT block for the OFDM case, additional well-known blocks are used in the OFDM receivers, such as cyclic prefix removal and synchronization blocks, but those are not shown in FIG. 5.

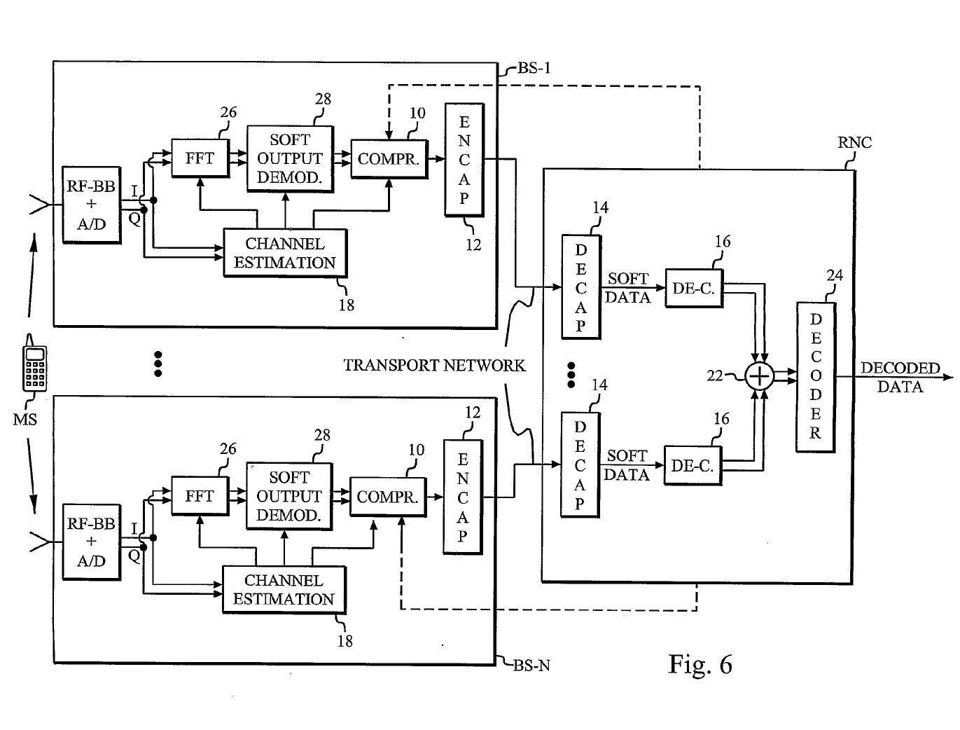

FIG. 6 is a block diagram of a third exemplary embodiment of a cellular radio network in accordance with the present invention. This is also an OFDM network, however, in this case the signal from FFT block 26 is forwarded to a soft output demodulator 28, and the soft output signal from the demodulator is compressed instead, for example by vector quantization. In this example a complex signal constellation, for example 4-QAM modulation, is assumed, which means tat the output signals from the demodulators represent complex signals as indicated by the double arrow lines. The channel estimate from channel estimator 18 is used to compensate for channel attenuation and phase shifting before demodulation. The compressed signals from the base stations are received by the RNC and decapsulated in blocks 14 and then de-compressed into complex signals in de-compressors 16. These complex signals are combined in adder 22 and the combined signal is decoded in decoder 24. Since the compensation is performed already in the base stations, the channel estimate is never sent to the RNC. However, preferably a reliability indicator, such as the channel attenuation or SNR per symbol should also be sent to the RNC for weighting during signal combination.

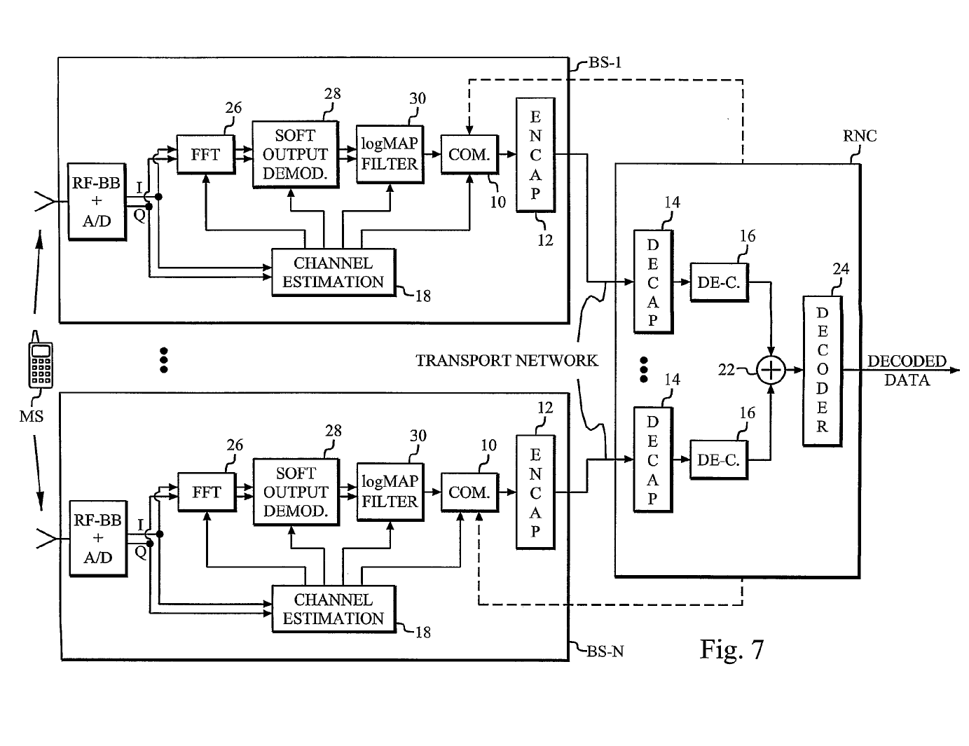

FIG. 7 is a block diagram of a fourth exemplary embodiment of a cellular radio network in accordance with the present invention. This embodiment is similar to the embodiment in FIG. 6, but goes one step further by logMAP (MAP=Maximum A Posteriori) filtering the soft output signal from demodulator 28 in a logMAP filter 30. MAP filtering and logMAP filtering are described in [3, 4] and are equivalent forms of a posteriori probability (APP) filtering. Basically the signal is channel decoded, but instead of information symbols, updated soft reliability values of code symbols are computed. No hard decision is made, which means no (or small) loss of information. Furthermore, the filtered version is less noisy and has lower entropy and thus is more compressible. Vector quantization is a suitable method for this. The compressed signals from the base stations are received by the RNC and decapsulated in blocks 14 and then de-compressed in de-compressors 16. These signals are combined in adder 22 and the combined signal is decoded in decoder 24.

A simplified version of MAP filtering that also can be used is the Soft Output Viterbi Algorithm (SOVA).

An advantage of the embodiment of FIG. 7 is that the resolution of the output samples from logMAP filter 30 may be drastically reduced. Typically 2-5 bits are sufficient, and as the following example will show, this can be compressed even further.

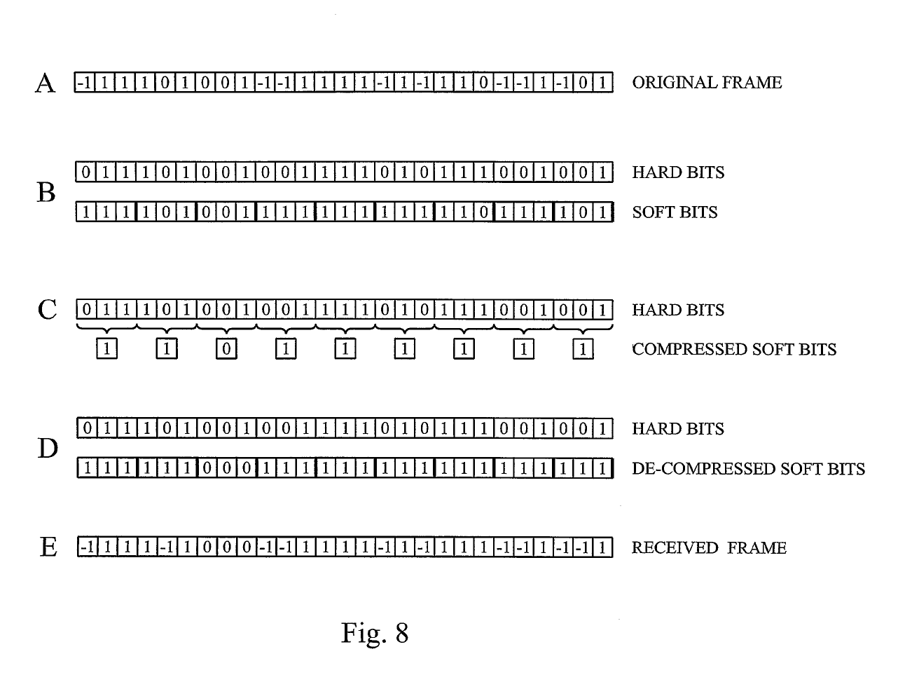

FIG. 8A-E illustrates an exemplary signal representation that can be used in the embodiment of FIG. 7. This embodiment assumes that each sample in the output signal from a logMAP filter 30 is represented by a three level signal, where +1 represents logical 1 (with probability 1) and −1 represents logical 0 (with probability 1) and 0 represents an undecided logical value. FIG. 8A is an exemplary frame including a few such samples (in practice frames may be much longer, but this is sufficient to illustrate the principle). Compressor 10 transforms this representation into a hard and a soft part. The hard bits are obtained by mapping +1 to logical 1 and −1 to logical 0. The undecided values 0 are mapped to logical 0 in this example to simplify the illustration. However, in a practical embodiment it is probably better to randomly select either 0 or 1 for such 0-samples. The soft part contains probability 1 for the “certain” sample values +1 and −1, and probability 0 for the undecided 0-samples. This transformation is illustrated in FIG. 8B for the frame in FIG. 8A. The next step is the compression of the soft bits illustrated in FIG. 8C. A lossless method would be run length encoding of the soft bits (the same method as in fax machines). Another (lossy) method is to group the soft bits into blocks (as indicated by the thick lines in FIG. 8B), and assign each block the value of the majority of the soft bits in the block (in the example there are only 3 bits in each block, but in practice the blocks may be larger). Thus, block 1 is assigned the value 1, since all soft probability values are equal to 1. Block 2 is also assigned the value 1, since 2 out of 3 soft bits are equal to 1. On the other and, block 3 is assigned the probability value 0, since 2 out of 3 soft bits are equal to 0. The compressed soft bits and the hard bits are sent to the RNC, where de-compression is performed in accordance with FIG. 8D. The de-compression is performed by filling the soft bits with the corresponding compressed block value. Finally, the representation in FIG. 8D is transformed back into the original three level (+1,0,−1) representation, as illustrated in FIG. 8E. These signals are added to similar signals from other base stations, and thereafter the combined signal is decoded.

Although the method described with reference to FIG. 8 illustrates that the compression can in fact reduce the required transfer capacity below 2 bits per transferred code bit, in practice vector quantization of the soft bits is a more realistic alternative.

In the various embodiments described above the compression used was mostly lossy, which means that the soft information can be restored only approximately. However, it should also be remembered that the obtained symbols are code symbols that still contain redundancy for performing error correction. Thus, the compression only represents another form of noise that in many cases may be removed by error correction methods before the final information symbols are obtained.

A further development of the present invention is to send decoded information bits (typically an Automatic Repeat reQuest (ARQ) Packet Data Unit (PDU)) together with compressed reliability values to the combining point. The PDU may preferably have a (cyclic redundancy) check sum that can be used to check correctness of combined and decoded packet. As is well-known from ARQ schemes, if a packet is incorrect, a retransmission takes place. The benefit of this scheme is that only slightly more than K bits times the number of BSs considered are transmitted. The scheme relies utterly upon the compressed reliability (soft) information (or similarly compressed channel information) for combining of information bits received from at least two BSs. Although one risks that the combining and decoding fails occasionally, overall with ARQ, less information needs to be transported in the network with preserved performance.

A further enhancement of the invention is to use feedback from the RNC containing decompression units and a combining unit, allowing for adaptive compression. This has been indicated by the dashed feedback lines in FIGS. 4, 6 and 7 (a similar feature may also be added to the embodiment in FIG. 5, but this has not been explicitly shown to avoid cluttering of the figure). One basic type of feedback and compression adaptation is that the RNC conveys (potentially different) threshold levels to the involved BSs (for each user stream). This threshold is used as a quality reference to decide which information to send or not. For instance, if the channel magnitude is sent to the RNC (compressed or not), the channel magnitude is compared to the threshold level, and only those bits exceeding the threshold are sent. As both the threshold and the channel magnitude are known in the RNC, the position for the unsent bits can be restored. In the combining and decoding procedure, those blanks and the upper quality limit (given by the used threshold) is exploited. The concept of using indications of erased (or blanked) symbols is well-known for instance for Reed-Solomon decoding, and enables improved decoding capability. The same principle can also be applied on reliability values, instead of channel magnitude information, assuming that the reliability values are also made known in the RNC. The described principle may be applied on coded bits, but also decoded information bits, both with associated compressed reliability, channel magnitude or other quality related information. The overall benefit of this scheme is that one avoid sending unreliable bits, and in the optimum case approaches transmitting only slightly more than K bits, if decoded bits are sent, or N bits if encoded bits are sent. Over time, as the quality changes at the different BSs, the RNC may adaptively change the threshold levels to achieve desired performance objectives, such as achieving a desired throughput with minimal transport network utilization or maximizing throughput while maintaining transport network resource utilization at approximately constant level. Other compression adaptation is also possible, such as adapting codebooks used in the BSs in response to combining and decoding performance in the RNC.

Moreover, the compression entity (such as any used codebook) may also be adapted in response to various used communication parameters, such as but not limited to PHY layer parameters comprising modulation, forward error correction and interleaver format.

In the described embodiments there are control lines from channel estimator 18 to the compression unit. These control lines indicate that the compression may be adapted to the quality of the channel. For example, different code-books may used for a poor or a good channel. If the channel estimate is not sent to the RNC, a codebook indicator may be sent instead.

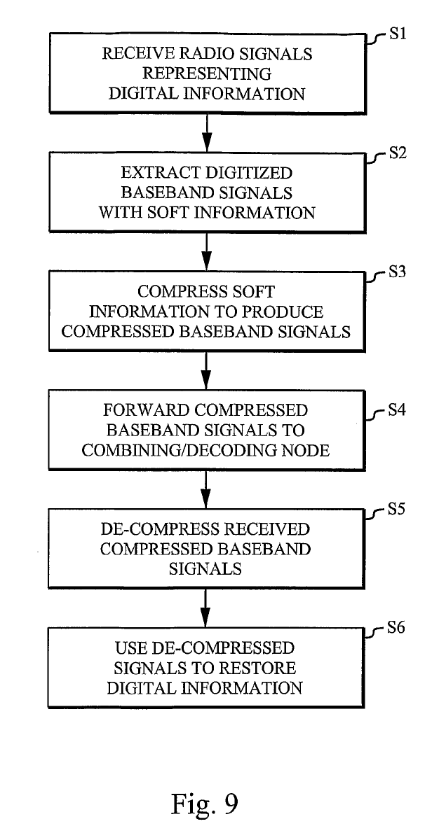

FIG. 9 is a flow chart of an exemplary embodiment of the method in accordance with the present invention. In step S1 radio signals representing digital information from a mobile station are received. Step S2 extracts a digitized baseband signal that contains soft information from each received radio signal. Step S3 compresses the soft information to form compressed baseband signals. Step S4 forwards the compressed baseband signals to a combining and decoding unit over a transport network. Step S5 de-compresses the forwarded signals to restore the baseband signals. Finally step S6 uses the de-compressed signals to restore the digital information.

The embodiments of the invention described above all related to a soft handover scenario. However, other applications are also possible.

One example of such an application is where several base stations receive radio signals from several mobile stations for joint detection. In this case the joint detection can be moved from the base stations to the central decoding node. However, this requires that the soft signals that are transferred from the base stations to the decoding node retain both amplitude and phase information, such that interference can be suppressed and signal to noise ratio is maximized.

Another application is a cellular system with simplified base stations, where most of the actual decoding is performed in the central decoding node. This node may or may not combine the received compressed information with information from other base stations. In such a system most of the computational burden is handled by the central node, while the base stations are kept fairly simple to reduce cost. This feature could be used to have more densely distributed base stations.

In the embodiments of the present invention described above, more or less digital signal processing may be performed at the base stations. This signal processing requires sufficient digital resolution in the input data to provide meaningful output data. However, once this processing has been performed, the output data need not necessarily have the same resolution as the input data. This implies that the more processing that is performed in the base stations, the less strict are the resolution requirements on the output data. On the other hand, the less processing that is performed in the base stations, the more processing remains in the decoding node, which means a higher required resolution in the data to be transferred over the transport network. Thus, more processing in the base stations generally translates into less burden on the transport network and the decoding node, and vice versa.

The various blocks in the described embodiments of the present invention are typically implemented by a microprocessor, a digital signal processor or a micro/signal processor combination and corresponding software, However an ASIC (Application Specific Integrated Circuit) is also feasible.

It will be understood by those skilled in the art that various modifications and changes may be made to the present invention without departure from the scope thereof, which is defined by the appended claims.

### REFERENCES

[1] U.S. Pat. No. 6,320,852.
[2] U.S. Pat. No. 5,867,791.
[3] I. Land, P. Hoeher, U. Sorger, “On the Interpretation of the APP Algorithm as an LLR Filter”, ISIT200, Italy, Jun. 25-30, 2000.
[4] P. Robertson, P. Hoeher, and E. Villebrun, “Optimal and suboptimal maximum a posteriori algorithms suitable for turbo decoding,” Europ. Trans. Telecommun., vol. 8, no. 2, March 1997, pp. 119-125.

1. A multiple path information transfer method in a cellular radio network, including the steps of
receiving, at several receivers connected to a transport network, radio signals representing digital information from at least one signal source;
extracting, from each received radio signal, a corresponding digitized baseband signal that at least partially contains soft information;
compressing at least parts of the soft information of said extracted baseband signals into a de-compressible form to form compressed baseband signals;
forwarding said compressed baseband signals to a combining unit over said transport network;
de-compressing said forwarded signals to at least approximately restore said baseband signals; and
using said de-compressed signals to at least approximately restore said digital information.

2. The method of claim 1, including the step of performing noise suppression on at least parts of said extracted baseband signals before compression.

3. The method of claim 2, wherein said noise suppression is performed by a posteriori probability filtering.

4. The method of claim 3, wherein said noise suppression is performed by maximum a posteriori filtering.

5. The method of claim 3, wherein said noise suppression is performed by log maximum a posteriori filtering.

6. The method of claim 2, wherein said noise suppression is performed during soft output demodulation.

7. The method of claim 2, wherein said noise suppression is performed on the output signal from a soft output demodulator.

8. The method of claim 1, wherein said compressing step includes vector quantization of at least parts of the soft information.

9. The method of claim 1, wherein the compression in said compressing step is lossy.

10. The method of claim 1, including the step of selecting compression mode for said soft. information at least partially based on at least one feedback signal from said combining unit.

11. The method of claim 1, including the step of selecting compression mode for said soft information at least partially based on channel estimates.

12. A multiple path information transfer system in a cellular radio network, said system including
several receivers (BS-1, . . . , BS-N), connected to a transport network, for receiving radio signals representing digital information from at least one signal source;
means for extracting, from each received radio signal, a corresponding digitized baseband signal that at least partially contains soft information;
means (10; 10A, 10B) for compressing at least parts of the soft information of said extracted baseband signals into a de-compressible form to form compressed baseband signals;
means (12, 14) for forwarding said compressed baseband signals to a combining unit over said transport network;
means (16; 16A, 16B) for de-compressing said forwarded signals to at least approximately restore said baseband signals; and
means (18-24) using said de-compressed signals to at least approximately restore said digital information.

13. The system of claim 12, including a noise suppressor (28, 30) performing noise suppression on at least parts of said extracted baseband signals before compression.

14. The system of claim 13, wherein said noise suppression is performed by a posteriori probability filters (28; 30).

15. The system of claim 14, wherein said noise suppression is performed by maximum a posteriori filters (28; 30).

16. The system of claim 14, wherein said noise suppression is performed by log maximum a posteriori filters (28; 30).

17. The system of claim 13, wherein said noise suppression is performed by soft output demodulators (28).

18. The system of claim 13, wherein said noise suppression is performed by filters (30) filtering output signals from soft output demodulators.

19. The system of claim 12, including means for vector quantization of at least parts of the soft information.

20. The system of claim 12, wherein said means for compressing is adapted to perform lossy compression.

21. The system of claim 12, including means for selecting compression mode for said soft information at least partially based on at least one feedback signal from said combining unit.

22. The system of claim 12, including means for selecting compression mode for said soft information at least partially based on channel estimates.

23. A base station in a digital radio network, said base station including
a receiver for receiving a radio signal representing digital information from at least one signal source;
means for extracting a digitized baseband signal, which at least partially contains soft information, from said received radio signal; and
means (10; 10A, 10B) for compressing at least parts of the soft information of said extracted baseband signal into a de-compressible form to form a compressed baseband signal.

24. The base station of claim 23, including a noise suppressor (28, 30) performing noise suppression on at least parts of said extracted baseband signal before compression.

25. The base station of claim 24, wherein said noise suppression is performed by an a posteriori probability filter (28; 30).

26. The base station of claim 25, wherein said noise suppression is performed by a maximum a posteriori filter (28; 30).

27. The base station of claim 25, wherein said noise suppression is performed by a log maximum a posteriori filter (28; 30).

28. The base station of claim 24, wherein said noise suppression is performed by a soft output demodulator (28).

29. The base station of claim 24, wherein said noise suppression is performed by a filter (30) filtering output signals from a soft output demodulator (28).

30. The base station of claim 23, including means (10; 10A, 10B) for vector quantization of at least parts of the soft information.

31. The base station of claim 23, wherein said means for compressing is adapted to perform lossy compression.

32. The base station of claim 23, including means for selecting compression mode for said soft information at least partially based on at least one feedback signal from an external unit.

33. The base station of claim 23, including means for selecting compression mode for said soft information at least partially based on channel estimates.

34. A signal combining unit in a cellular radio network, said combining unit including
means (14) for receiving multiple signals from a transport network, each signal at least partially containing compressed soft information;
means (16; 16A, 16B) for de-compressing said soft information to form corresponding de-compressed baseband signals from said received signals, and
means (18-24) for combining said baseband signals based on said de-compressed soft information.

35. The signal combining unit of claim 34, including at least one lookup table for de-compressing vector quantized soft information.

36. The signal combining unit of claim 34, including means for sending at least one control signal to compression units to assist in selecting compression mode for said soft information.

37. A signal decoder node in a cellular radio network, said decoder including
means (14) for receiving a signal from a transport network, said signal at least partially containing compressed soft information;
means (16; 16A, 16B) for de-compressing said soft information to form a corresponding de-compressed baseband signal from said received signal, and
means (24) for decoding said de-compressed baseband signal based on said de-compressed soft information.

38. The signal decoder of claim 36, including at least one lookup table for de-compressing vector quantized soft information.

39. The signal decoder of claim 37, including means for sending at least one control signal to a compression unit to assist in selecting compression mode for said soft information.
